(19) United States
(12) Patent Application Publication
(10) Pub. No.: US 2025/0309572 A1
(43) Pub. Date: Oct. 2, 2025

(54) UNITARY RF COAXIAL CONNECTOR FOR A BOARD-TO-BOARD OR BOARD-TO-FILTER OR BOARD-TO-MODULE CONNECTION, HAVING THREE ADJACENT COAXIAL LINES OF INCREASING DIAMETER, AT LEAST ONE OF WHICH IS SLIDABLE INTO ANOTHER, WITH CONSTANT IMPEDANCE MATCHING ALONG THE AXIS OF THE CONNECTOR

(71) Applicant: RADIALL, AUBERVILLIERS (FR)

(72) Inventors: Claude BROCHETON, COUBLEVIE (FR); Laurent PETIT, SAINT JEAN DE MOIRANS (FR)

(21) Appl. No.: 19/086,332

(22) Filed: Mar. 21, 2025

(30) Foreign Application Priority Data
Mar. 28, 2024 (FR) 2403201

(51) Int. Cl. H01R 12/73; H01R 12/70; H01R 12/71; H01R 13/03; H01R 13/24; H01R 13/506

(52) U.S. Cl. CPC H01R 12/73; H01R 12/7064; H01R 12/707; H01R 12/716; H01R 13/03; H01R 13/2421; H01R 13/506

(57) ABSTRACT

The application relates to a unitary coaxial connector, for transmitting radio frequency, RF, signals, having a longitudinal axis X, comprising three coaxial lines that are adjacent along the axis X, are substantially devoid of a solid electrical insulator, have constant nominal impedances on each coaxial line regardless of the length of each of the coaxial lines, the nominal impedances preferably being equal, and at least one of which nests by sliding into another, adjacent one, and the diameters of central and outer contacts of which increase from one longitudinal end of the connector to the other, with a peripheral guide element for guiding and recentering the sliding outer contact over a long movement length.

### CROSS-REFERENCE TO RELATED APPLICATIONS

This application claims priority to French Application No. FR2403201 filed on Mar. 28, 2024, the entire disclosures of which are hereby incorporated herein by reference.

### TECHNICAL FIELD

The present invention relates to the field of electrical connection and more particularly to a unitary RF connector.

Such a unitary connector can in particular be used to connect two parallel printed circuits, usually called a board-to-board (B2B) or printed circuit board (PCB) connection, to another component such as a module or a filter, generally called board-to-filter or board-to-module.

The applications particularly targeted by the invention are the connection of telecommunication equipment such as base transceiver stations BTS, RRU/RRH (Remote Radio Unit/Remote Radio Head) units, the antenna-integrated RRU/RRH solution, massive MIMO telecom antenna applications and distributed antennas of systems for the wireless communications market.

The invention also relates generally to connectors in the telecommunications field, in the medical field, in the industrial field, in the aeronautical field, in the transport field and in the space field.

The connectors according to the invention can in particular be used to connect two parallel printed circuits, usually called a board-to-board or printed circuit board connection system, to another component such as a module, a filter or a power amplifier or an antenna, or module-to-module.

“RF connector” means a connector capable of transmitting signals from the direct current (DC) range to the radio frequency (RF) range, including the microwave (HF) range, the signals being high speed data link (HSDL) digital signals or radio frequency (RF) signals.

“Unitary” is understood to mean that the connector according to the invention, once assembled, forms a single object.

### PRIOR ART

With the continuous development of wireless communication technology, board-to-board connectors are increasingly being used in the interconnection of wireless system modules, such as communication base stations, RRHs, repeaters, GPS devices and other similar applications. The top three trends in wireless devices are smaller dimensions, lower cost and easier installation, and also the upscaling of the frequency of the RF signals used. For a board-to-board connection, the market also requires the boards to be smaller, cheaper and more modularized.

Examples of connection assemblies dedicated to the telecommunications sector for cellular radiotelephony interconnections already exist on the market and in the prior art. This is because the trend in this market is to minimize the losses of the RF (radio frequency) part in order to reduce the amplifier components of the base stations. To that end, firstly, the present radio part of the stations is increasingly being relocated as close as possible to the transmit-receive antennas, in the RRU/RRH transmitter modules, and, secondly, the RF cables internal to the radio units are replaced by direct interconnections.

So-called board-to-board connections have thus developed over successive generations of the last decade.

There are already commercial products for producing these connections, in particular unitary products.

Mention may be made here of the connectors of the IMP series in the name of the applicant, as described in the patent EP1028490B1. These connectors are not suitable for all configurations, due in particular to a short axial travel and a low radial positioning tolerance. Also, the frequencies for which these connectors are intended are not high.

Mention may also be made of the coaxial compression connectors sold by the TYCO ELECTRONICS company under commercial reference 619127-1. These connectors are bulky due to their large diameter for board-to-board applications. They also have a short axial travel and a reduced operating frequency range.

Furthermore, the U.S. Pat. No. 6,776,668B1 discloses a coaxial connector for a board-to-board connection that is suitable for compensating for an angular defect between printed boards, up to 3°. However, the connector is not suitable for providing a wide range of axial distance between the two boards.

More generally, there is a need to further improve board-to-board or board-to-module or board-to-filter connections, in particular to meet the specifications set by the inventors, namely:
a connector of very simple structure, which consists of a minimum of spare parts, and which minimizes the environmental impact by not using hazardous substances such as per- and polyfluoroalkyl substances (PFAS), lead or beryllium;
a simple structure and low-cost connector;
the possibility of using a connector reference for a wide range of axial positioning between two parallel printed boards, typically from +/−1 mm or to +/−1.5 mm;
the possibility of connecting two parallel printed boards that are radially offset from each other, typically with a radial misalignment of from +/−0.5 mm to +/−1 mm;
a bulkiness, and therefore an outer diameter, of typically less than 5 mm;
a direct current, DC, operating frequency range to 20 GHz.

The invention aims to address all or part of this need.

### SUMMARY OF THE INVENTION

To this end, the invention relates, according to one of its aspects, to a unitary coaxial connector, for transmitting radio frequency, RF, signals, of longitudinal axis X, comprising:
three coaxial lines that are adjacent along the longitudinal axis X and increase in diameter from one adjacent line to the other, from one of the longitudinal ends of the connector to the other of its longitudinal ends, each of the lines comprising a central contact and an outer contact arranged around the central contact, at least one central contact of a coaxial line being slidable into a central contact of one of the other lines adjacent thereto, at least one outer contact of a coaxial line being slidable into an outer contact of one of the other lines adjacent thereto, so that the length of the intermediate coaxial line can vary, the volume between the central contact and the outer contact of the intermediate line being devoid of a solid electrical insulator;
a guide element, preferably in the form of a hollow tube, the internal surface of which is suitable for mechanically guiding at least the outer contact of the coaxial line which extends from one of the longitudinal ends of the connector.

“Devoid of a solid electrical insulator” is understood to mean that the electrical insulator consists of air or an electrically nonconductive gas, for example nitrogen, or a vacuum.

“Integral” is understood to mean fixed or produced integrally with.

“Intermediate coaxial line” is understood to mean the coaxial line arranged between the two end coaxial lines.

Preferably, the guide element is suitable for guiding the larger-diameter outer contact.

According to another advantageous variant embodiment, the guide element is integral with the outer contact of the coaxial line which extends from the other of the longitudinal ends of the connector, which is opposite to that from which the outer contact mechanically guided by the guide tube extends.

Preferably, the guide element is integral with the smaller-diameter outer contact.

According to another advantageous embodiment, the guide element is overmolded around the outer contact of the coaxial line.

According to this embodiment, the guide element is also overmolded to form an electrical insulating block. This electrical insulating block is used to accommodate and mechanically retain the central contact of at least the first coaxial line.

Advantageously, the guide element is also suitable for mechanically retaining the outer contact of the coaxial line, preferably for forming an axial stop for the latter.

The central contacts of the coaxial lines are form by a first electrically conductive body having at least two different diameters that form the central contact of the first coaxial line and the central contact of the second coaxial line, respectively, and by a second electrically conductive body that forms the central contact of the third coaxial line, which is slidable over the central contact of the second coaxial line, which is larger in diameter than that of the first coaxial line, the first electrically conductive body extending from the one of the longitudinal ends of the connector and the second electrically conductive body extending from the other of its longitudinal ends. Advantageously, such forming of the central contacts of the coaxial lines ensures stable electrical contact with low resistance between the coaxial lines.

Preferably, the second electrically conductive body comprises an open end comprising petals in mechanical and electrical contact on the outer surface of the first electrically conductive body.

According to an advantageous variant embodiment, a single coaxial line is slidable into another coaxial line, the third coaxial line, which is larger in diameter, the outer contact of the third coaxial line being integral with the outer contact of the second line with a narrowing in diameter.

According to an advantageous embodiment, the unitary coaxial connector comprises:
a third electrically conductive body that forms the outer contact of a first coaxial line, which is integral with the guide element, preferably by being overmolded with the latter;
a fourth electrically conductive body having two different diameters that form the outer contact of a second coaxial line and the outer contact of a third coaxial line, respectively, the outer contact of the second coaxial line being slidable over the outer contact of the first coaxial line, the outer contact of the third coaxial line, which is larger in diameter than that of the second coaxial line, being mechanically guided by the guide element.

According to another advantageous embodiment, the connector comprises at least one elastic return means for returning the fourth electrically conductive body to an unfurled end position relative to the third electrically conductive body. This elastic return means provides for the movement of the sliding outer contact and the contact force with a PCB to which the connector is intended to be electrically connected.

In this other embodiment, the elastic return means consists of a helical spring which is wound around between the guide tube and the smaller-diameter outer contact of the fourth electrically conductive body and in axial abutment firstly against a shoulder of the guide element and secondly against the shoulder that forms the junction between the smaller-diameter outer contact and the larger-diameter outer contact of the fourth body.

According to another advantageous embodiment, the connector comprises at least one elastic return means for returning the second electrically conductive body to an unfurled end position relative to the first electrically conductive body. This elastic return means provides for the movement of the slidable central contact and the contact force with a PCB to which the connector is intended to be electrically connected.

According to this other embodiment, the elastic return means consists of a helical spring which is accommodated in a bore in the larger-diameter central contact of the first electrically conductive body and in axial abutment against the blind end of a tube that forms the central contact of the second electrically conductive body.

According to an advantageous embodiment:
the guide element is electrically conductive and integral with the outer contact formed by the third electrically conductive body;
the first electrically conductive body comprises a cylindrical sleeve that forms the central contacts of the first and second coaxial lines and a contact tip mounted so as to be axially mobile in the sleeve with an axial stop;
the second electrically conductive body that forms the central contact of the third coaxial line being mounted so as to be slidable relative to the fourth electrically conductive body that forms the outer contact of the second coaxial line and the outer contact of the third coaxial line, in such a way that the force exerted by each of the elastic return means can produce the electrical connection between, firstly, at one of the longitudinal ends of the connector, the contact tip and the guide element and, respectively, the signal track and the ground track of a first printed circuit board (PCB1) and, secondly, at the other of the longitudinal ends of the connector, the central contact and the outer contact of the third coaxial line and, respectively, the signal track and the ground track of a second printed circuit board (PCB2).

Thus, according to this embodiment, it is possible to produce a board-to-board electrical connection (PCB1, PCB2) exclusively by mechanical application force, and therefore without any welding/soldering being necessary.

According to an advantageous insulation alternative, the connector comprises an electrically insulating block arranged between the outer contact and the central contact of the third coaxial line over at least a portion of the axial length of the latter, the electrically insulating block comprising at least one axial through hole. This insulating block improves the mechanical holding of the slidable central contact. The axial hole(s) along the length of the sliding coaxial line maintain(s) a constant impedance. In this alternative, the diameter of the sliding coaxial line is increased.

According to an advantageous variant, the guide element comprises centering and/or mechanical retention feet suitable for positioning and/or pre-assembling, preferably by means of press-fitting or snap-fitting, the element and thus the connector for a printed circuit board (PCB1) to which a coaxial line of the connector is intended to be connected by being secured, in particular soldered.

The guide element, and if appropriate the electrically insulating block, is (are) advantageously made of an electrically insulating material chosen from an aliphatic polyamide (PA), a liquid crystal polymer (LCP), polyetheretherketone (PEEK) or a mixture thereof. Any use of plastic materials from the PFAS family is thus eliminated.

Preferably, the material of which the contacts are made is a copper alloy devoid of lead and beryllium.

Advantageously, the outer contact of one of the coaxial lines at one longitudinal end of the connector comprises at least one lug intended to be used for permanent electrical and mechanical connection to a printed circuit board (PCB1). The connection is thus facilitated and reinforced, in particular by providing a large soldering surface.

According to an advantageous structure, the outer contact of one of the coaxial lines at one longitudinal end of the connector comprises, at its free end, two concentric flanges, one inside the other to form two staircase steps, the outer flange of which extends radially outwards. This increases the radial misalignment acceptable to the connector, without affecting the impedance of the sliding coaxial line.

The invention also relates to a coaxial connector assembly, in particular for connecting two printed circuit boards (PCB1, PCB2) or one board to a filter or one board to a module, comprising:
at least one unitary coaxial connector as described above, of which one of the coaxial lines at one longitudinal end of the connector is intended to be connected by being secured, in particular soldered, to a first printed circuit (PCB1),
at least one interconnection plate, one main face of which is intended to be connected by being secured, in particular soldered, to a second printed circuit board (PCB2) or to a module or to a filter, and the other main face of which is intended to be connected to another of the coaxial lines at the other longitudinal end of the connector.

Preferably, the other of the coaxial lines at the other longitudinal end of the connector which is intended to be connected to the other main face of the interconnection plate is the sliding one. The coaxial connection assembly can be multi-way and comprise:
multiple coaxial connectors arranged parallel to each other;
multiple interconnection plates, each intended to be connected to the other of the coaxial lines of each connector.

Another subject of the invention is a method for producing a unitary coaxial connector as described above, comprising the following steps:
i/ supplying a third electrically conductive body that forms the outer contact of a first coaxial line;
ii/ supplying a fourth electrically conductive body having two different diameters that form the outer contact of a second coaxial line and the outer contact of a third coaxial line, respectively,
iii/ mechanically assembling a first connector subassembly comprising a first electrically conductive body having at least two different diameters, which form the central contact of the first coaxial line and the central contact of the second coaxial line, respectively, and a second electrically conductive body that forms the central contact of the third coaxial line, which is slidable over the central contact of the second coaxial line, which is larger in diameter than that of the first coaxial line;
iv/ overmolding the guide element on the third electrically conductive body so as to form a second connector subassembly and then mechanically assembling the first subassembly in the second subassembly;
or
iv/′ overmolding the guide element both on the third electrically conductive body and on the central contact of the first coaxial line of the first connector subassembly so as to form a second connector subassembly;
v/ mechanically assembling the fourth electrically conductive body in the second subassembly in such a way that the outer contact of the second coaxial line slides over the outer contact of the first coaxial line and the guide element mechanically guides the outer contact of the third coaxial line.

Preferably, overmolding step iv/is carried out so as to form an electrically insulating block in the form of a hollow tube suitable for accommodating the central contact of the first coaxial line.

According to an advantageous variant, assembly step iii/is carried out with a central contact of the third coaxial line in the form of a blind tube and with a central contact of the second coaxial line provided with a bore, and by accommodating a helical spring in the bore in axial abutment against the blind end of the tube.

According to another advantageous variant, assembly step v/is carried out by previously accommodating a helical spring around the outer contact of the first coaxial line, in axial abutment firstly against a shoulder of the guide element and secondly against the shoulder that forms the junction between the outer contact of the second coaxial line and that of the third coaxial line.

Thus, the invention essentially consists of a unitary coaxial connector comprising three coaxial lines that are substantially devoid of a solid electrical insulator, have constant nominal impedances on each coaxial line regardless of the length of each of said coaxial lines, the nominal impedances preferably being equal, and at least one of which nests by sliding into another, adjacent one, and the diameters of central and outer contacts of which increase from one longitudinal end of the connector to the other, with a peripheral guide element, preferably in the form of a tube, for guiding and recentering the sliding outer contact over a long movement length.

The characteristic impedance of each coaxial line and of the entire connector remains at a stable value, typically 50 ohms, over the entire length of the connector, regardless of the final distance between the PCBs to be connected by the connector. It is also possible to obtain a stable impedance over the entire length of the connector at 75 ohms or any other value. There is no impedance mismatch along the axis of the connector in passing from one coaxial line to another: the presence of air predominantly in the coaxial lines avoids impedance variations between areas of solid insulation and air insulation that can be found in connectors according to the prior art.

The length adaptation of the connector according to the invention to match the different distances between PCBs to be connected is carried out by varying the length of the sliding coaxial line:
the outer or ground contact slides outside the body of the smaller-diameter outer or ground contact belonging to an end coaxial line, decreasing or increasing the length of the sliding coaxial line;
the central contact belonging to an end coaxial line slides above the smaller-diameter central contact, decreasing or increasing the length of the sliding coaxial line.

The invention has many advantages over prior-art connectors, including:
the possibility of getting large axial misalignments, typically of the order of 2.4 mm variation in the distance between two PCBs to be connected, without changing the impedance of the coaxial lines according to the distance between PCBs, which remains stable, typically equal to 50 2;
the absence of solid electrical insulators, which leaves air as the insulator, whose lowest dielectric constant reduces the dimensions (diameters) of coaxial lines and produces a compact connector. By way of example, the larger-diameter coaxial line may have an outer contact that is 3.5 mm in diameter and a central contact of 1.5 mm;
the functional separation between parts with electrical functions, such as outer contacts, and the outer guide tube with mechanical functions for guiding and retaining the sliding outer contact allows the use of materials that are most suitable for these functions:
   the tube may be made of plastic material, preferably overmolded on the smaller-diameter fixed outer contact,
   the bodies of the outer or ground contacts, due to their simplicity of geometry, do not require the use of a copper alloy comprising beryllium or lead, which produce increased elasticity in copper alloys,
   the small number of connection maneuvers required for the connector requires lower mechanical performance from the materials used in the metal parts and therefore also allows the use of copper alloys without beryllium or lead,
   electrical parts having a current carrier function, which do not perform a structural mechanical function, can be produced with very low thicknesses, which allows a saving in material, weight, cost . . . ,
   the main use of air lines, if necessary with the most compact solid insulator possible, avoids the use of plastics from the PFAS family. The plastics used for the tube and the solid insulator can be from the PA, LCP, PEEK family. These plastics combined with the use of metals without beryllium or lead for the contacts therefore avoid the use of hazardous or prohibited substances;
   the possibility of a large axial misalignment, typically equal to +/−1.2 mm, facilitated by the guidance of the sliding outer contact by the guide tube;
   the possibility of a large radial misalignment on a PCB to be connected, typically equal to +/−0.75 mm, by the end shapes of the central and outer sliding contacts and by the sliding nesting of the coaxial lines;
   the simplicity of geometry of the components of the connector and their assembly;
   reduced component and assembly costs;
   a high operating frequency due to the stability of the impedance of the coaxial lines, which is typically equal to 20 GHz with an impedance of 50 ohms.

Other advantages and features of the invention will become more clearly apparent upon reading the detailed description of exemplary implementations of the invention, given by way of non-limiting illustration with reference to the following figures.

### BRIEF DESCRIPTION OF THE DRAWINGS

FIGS. 1, 1A and 1B show perspective and longitudinal section views, respectively, of an example of a unitary coaxial connector according to a first embodiment of the invention, FIGS. 1A and 1B being produced according to the same sectional plane but with a greater compressing travel for FIG. 1B.

FIG. 2 is an exploded view of the connector according to FIGS. 1 to 1B.

FIG. 3 is a perspective view of an outer contact of a coaxial line at one end of the connector according to FIGS. 1 to 1B.

FIG. 4 is a perspective view of another connector subassembly comprising the three central contacts of the coaxial lines of the connector according to FIGS. 1 to 1B.

FIG. 5 is a perspective and longitudinal section view of a connector subassembly comprising an outer contact according to FIG. 3 and a guide tube overmolded on said contact.

FIG. 6 is a perspective and longitudinal section view of a unitary coaxial connector according to an alternative of the invention.

FIG. 7 is a perspective view of an interconnection plate intended to be inserted between a longitudinal end of a unitary coaxial connector according to the invention and a PCB.

FIG. 8 is a perspective view of a PCB provided with a plurality of interconnection plates according to FIG. 7 for producing a multi-way coaxial connection assembly.

FIG. 9 is a perspective view of a multi-way coaxial connection assembly comprising a plurality of unitary coaxial connectors according to the invention that are arranged in parallel with each other and connected between a PCB and a PCB provided with the plurality of interconnection plates according to FIG. 8.

FIG. 10 shows a longitudinal section through an example of a unitary coaxial connector according to a second embodiment of the invention, which is intended to produce an electrical connection between two PCBs without welding.

FIG. 11 is an exploded view of the connector according to FIG. 10.

### DETAILED DESCRIPTION

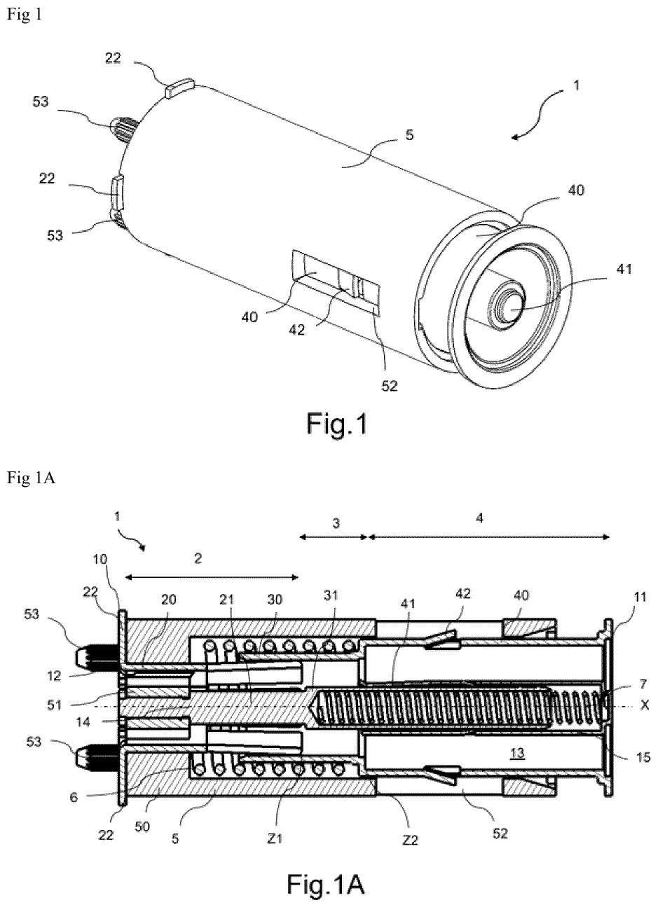

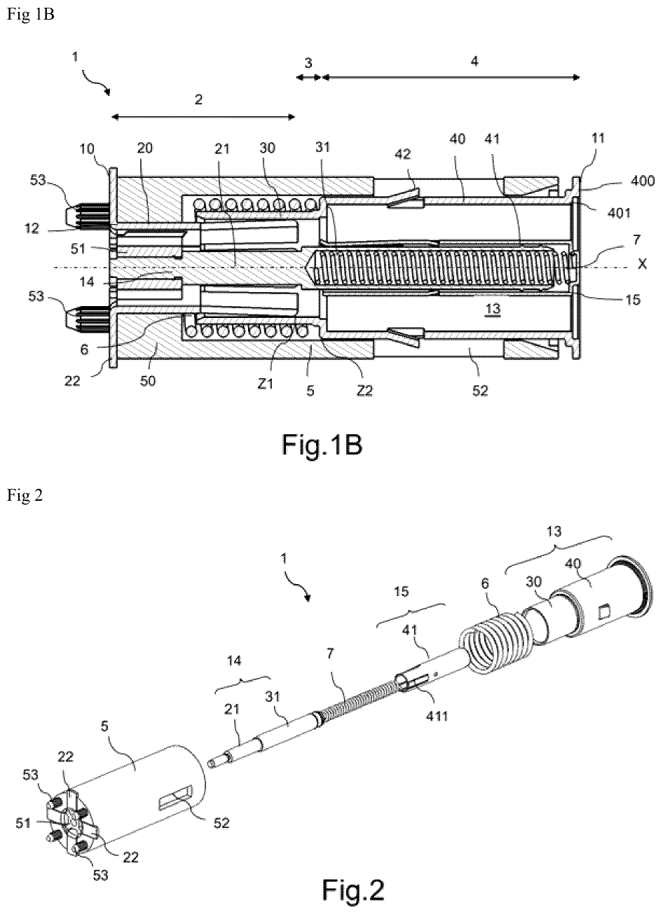

FIGS. 1 to 2 show a unitary coaxial connector 1 according to a first embodiment of the invention, in its assembled configuration, in an intermediate unfurled position.

The connector 1 extends along a longitudinal axis X and is assembled to form a single object intended to transmit radio frequency, RF, signals.

This unitary coaxial connector essentially comprises three coaxial lines 2, 3, 4 that are adjacent along the longitudinal axis X and increase in diameter from one adjacent line to the other, from one of the longitudinal ends 10 of the connector to the other 11 of its longitudinal ends. The increasing diameter of the coaxial lines produces, at one of the ends of the coaxial connector 1, a greater tolerance for radial misalignment with the device to be connected (PCB, filter, etc.).

These three lines 2, 3, 4 have constant nominal impedances over the length of each of the lines. Preferably, the nominal impedances of all the coaxial lines are equal.

The coaxial line 2 comprises an outer or ground contact 20 and a central contact 21 arranged inside the outer contact 20. The diameter of the central contact 21 is suitable for obtaining a constant impedance, typically 50 ohms, over the entire length of the coaxial line 2.

The coaxial line 3 comprises an outer or ground contact 30, which is larger in diameter than the outer contact 20, allowing an improvement in the continuity of the contacts and therefore in RF performance, and a central contact 31 which is arranged inside the outer contact 30 and is larger in diameter than the central contact 21. The outer contact 30 nests by sliding over the outer contact 20. The central contact 31 is integral, preferably formed integrally, with the central contact 21.

The coaxial line 4 comprises an outer or ground contact 40, which is larger in diameter than the outer contact 30, and a central contact 41 which is arranged inside the outer contact 40 and is larger in diameter than the central contact 31. The outer contact 40 is integral, preferably formed integrally, with the outer contact 30.

As illustrated, the outer contact 40 preferably comprises, at its free end, two concentric flanges 400, 401, one inside the other to form two staircase steps, the outer flange of which extends radially outwards. The inner concentric flange 401 offsets the bearing surface of the outer contact 40 that bears against the mass of the PCB or of the filter radially outwards. The outer concentric flange 400 creates the bearing surface of the outer contact that bears against the mass of the PCB or of the filter. The flare formed by the two concentric flanges 400, 401 at the end of the outer contact allows an increase in the radial misalignment tolerance. The central contact 41 nests by sliding over the central contact 31. The central contact 41 comprises, at its open end, petals 411 in mechanical and electrical contact on the outer surface of the central contact 31. The length of this central contact 41 is exactly that of the coaxial line 4, allowing the latter to have a constant impedance.

As can be seen in FIGS. 1A and 1B, the volumes between the central contacts 21, 31, 41 and the outer contacts 20, 30, 40 are filled with air, or with an electrically nonconductive gas, or consist of a vacuum, that is to say without a solid electrical insulator, over at least the length of sliding along the longitudinal axis X. The absence of a solid electrical insulator in the coaxial line 3 allows the outer contact 20 to penetrate beneath the outer contact 30, and allows the central contact 41 to slide around the central contact 31.

A guide element 5, preferably in the form of a hollow tube, has an inner surface which is suitable for mechanically guiding the outer contact 40. As is evident from FIGS. 1A and 1B, this element in the form of an outer guide tube 5, preferably overmolded on the outer contact 20, acts as the mechanical structure of the connector. It therefore all at once stiffens this outer contact 20, by way of its base 50 surrounding said contact, protects all the outer contacts 20, 30, 40 and provides the mechanical strength of the connector 1. Owing to the long axial travel of the outer contact 40, the guide tube 5 prevents the outer contact 40 from veering off course, particularly when it is completely unfurled.

The guide element 5 is distinct from each of the coaxial lines 2, 3, 4, in particular from each external contact 20, 30, 40 of each of the coaxial lines 2, 3, 4.

This guide tube 5 is advantageously made of an electrically insulating material chosen from an aliphatic polyamide (PA), a liquid crystal polymer (LCP), polyetheretherketone (PEEK) or a mixture thereof.

The entirely tubular shape of the element 5 reduces the overall size of the connector. However, only its tubular inner surface is used for guiding, its outer shape being able to vary according to applications or needs.

The coaxial line 3 has a variable electrical length due to the synchronous sliding of the ground contact 30 over the ground contact 20 and the sliding of the central contact 41 over the central contact 31.

The transition zones Z1 between, firstly, the coaxial lines 2 and 3 and Z2 between, secondly, the coaxial lines 3 and 4 have an invariant design, that is to say diameter ratios between the ground contact and the central contact that are equal, with a stable impedance, typically equal to 50 ohms, regardless of the unfurled position, that is to say sliding of the coaxial lines of the connector. This allows the connector 1 according to the invention to be operated beyond 12 GHz, preferably up to 20 GHz.

In the embodiment illustrated in FIGS. 1 to 1B, the unitary coaxial connector 1 comprises:
a first electrically conductive body 14 having two different diameters that form the central contact 21 of the coaxial line 2 and the central contact 31 of the coaxial line 3, respectively;
a second electrically conductive body 15 that forms the central contact 41 of the coaxial line 4 sliding over the central contact 31 of the coaxial line 3;
a third electrically conductive body 12 that forms the outer contact 20 of the coaxial line 2, the guide tube 5 having its base portion 50 overmolded around;
a fourth electrically conductive body 13 having two different diameters that form the outer contact 30 of the coaxial line 3 and the outer contact 40 of the coaxial line 4, respectively, the latter being mechanically guided by the guide tube 5.

A helical spring 6 is wound between firstly the guide tube 5 and secondly the outer contacts 20 and 30 and in axial abutment firstly against a shoulder of the guide tube 5 and secondly against the shoulder that forms the junction between the outer contact 30 and the outer contact 40. This spring 6 provides for the sliding of the outer or ground body 13 and the contact force with the PCB to which the longitudinal end 11 of the connector is intended to be connected.

A helical spring 7 is accommodated in a bore 310 of the central contact 31 and in axial abutment against the blind end 410 of a tube that forms the central contact 41. This spring 7 provides for the movement of the central contact 41 and the contact force with the PCB to which the longitudinal end 11 of the connector is intended to be connected.

These helical springs can be replaced by any other suitable elastic return means (spring washers, cut metal part, etc.).

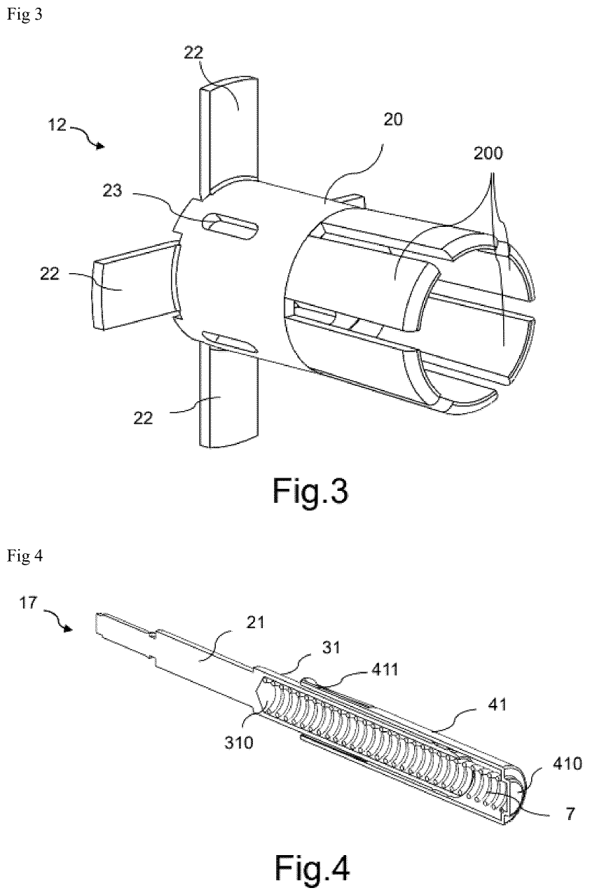

FIG. 3 shows the electrically conductive body 12 which forms the outer contact 20. The free end of the latter comprises petals 200 that provide for electrical contact, via their outer faces, with the outer contact 30 which slides on top. This configuration ensures a better contact pressure.

The base of the body 12 advantageously has lugs 22 orthogonal to the axis X which are intended to be used for permanent electrical and mechanical connection to a printed circuit board (PCB1), in particular by welding, allowing surface mounting in accordance with SMT technology. These lugs 22 could also be arranged parallel to the axis X for through-welding to the PCB, or press-fit mounting inside a hole in the PCB.

The body 12 also comprises, on its base, openings 23 that allow the guide tube 5 to be produced by overmolding on the body 12. Advantageously, this overmolding of the outer tube 5 also simultaneously produces an electrical insulating block 51, as illustrated in FIGS. 1A and 1B, in which a smaller-diameter portion of the central contact 21 is mechanically retained. The openings 23 have the shape of oblong through holes. Other shapes can be envisaged according to the technical requirements for overmolding the tube, and, if necessary, the electrical insulating block.

The outer guide tube 5 preferably comprises centering and/or mechanical retention feet 53 suitable for positioning and pre-assembling, preferably by means of press-fitting or snap-fitting, the tube and thus the connector for a printed circuit board (PCB1) to which the coaxial line 2 of the connector is intended to be connected by being secured, in particular soldered. This pre-assembly can be carried out by means of press-fitting or snap-fitting. The number of centering and/or mechanical retention feet can vary according to the technical requirements for mounting on the PCB.

Advantageously, the guide tube 5 also provides a mechanical retention and axial abutment function for the outer body 13. To do this, the outer contact 40 comprises outwardly oriented tongues or stamped portions 42 which each slide into a through opening 52 made in the guide tube 5 and can come into axial abutment against their edge.

The mechanical operation of the coaxial connector 1 is essentially as follows: for a connection between two PCBs or between a PCB and a filter or a module, the connector 1 can compress between its two longitudinal ends 10 and 11 on account of the reduction in length by way of sliding of the coaxial line 3. The outer or ground contact 30 slides outside the outer or ground contact 20 and the central contact 41 simultaneously slides over the central contact 31. The helical springs 6 and 7 provide the contact forces necessary for the electrical connection. The flanges 400, 401 of the outer contact 40 increase the acceptable radial misalignment, without affecting the impedance of the coaxial line 4 of the connector, owing to the short axial length of each of the flanges.

To arrive at the collapsed connection position of the connector 1, the bodies 13 and 15 move essentially synchronously in order to slide over the bodies 12 and 14, respectively, thus reducing the length of the coaxial line 3.

In some configurations of a connector 1 coming into contact with a PCB or a filter, the flange 401 of the outer contact 40 and the end 410 of the central contact 41 may be significantly offset longitudinally. In other words, the flange 401 and the end 410 need not be coplanar.

When the connector 1 is connected to this PCB or this filter, the flange 401 and the end 410 come into contact with the respective facing surfaces of the filter, mechanically prestressing the elastic elements 6 and 7.

The connector 1 is then collapsed between its two longitudinal ends 10 and 11 so as to end up at its connection length by way of sliding of the coaxial line 3. The outer ground contact 30 and the central contact 41 then slide simultaneously, over the outer contact 20 and the central contact 31, respectively.

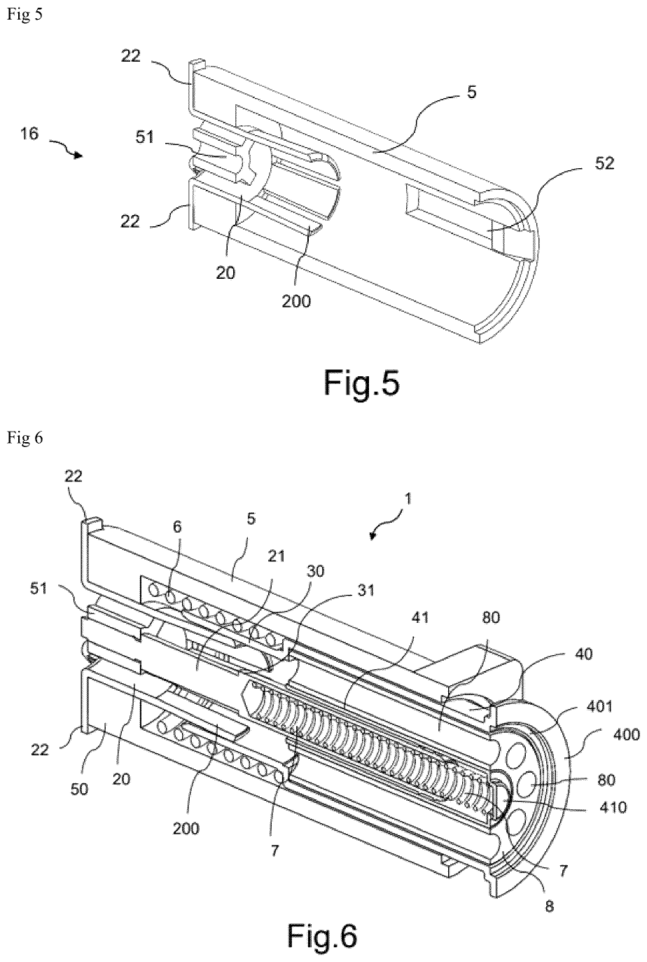

The method for assembling the unitary coaxial connector 1 that has just been described comprises the following steps:
i/ supplying the third electrically conductive body 12 that forms the outer contact 20 (FIG. 3);
ii/ supplying a fourth electrically conductive body 13 comprising two different diameters that form the outer contact 30 and the outer contact 40, respectively,
iii/ mechanically assembling a first connector subassembly 17 comprising a first electrically conductive body 14 having two different diameters, which form the central contact 21 and the central contact 31, respectively, and a second electrically conductive body 15 that forms the central contact 41, which is slidable over the central contact 31 (FIG. 4). This step iii/preferably comprises accommodating the helical spring 7 in the bore 310 in the central contact 31, which is in axial abutment against the free end 410 of the blind tube that forms the central contact 41;
iv/ overmolding the guide tube 5 on the third electrically conductive body so as to form a second connector subassembly 16 (FIG. 5) and then mechanically assembling the first subassembly 17 in the second subassembly 16. Preferably, the central contact 21 is held in the central electrical insulator 51 formed by the overmolding;
or
iv′/ overmolding the guide tube 5 both on the third electrically conductive body 12 and on the central contact 21 of the coaxial line 2 of the first connector subassembly 17 so as to form a second connector subassembly;
vi/ mechanically assembling the fourth electrically conductive body 13 in the second subassembly 16 so that the outer contact 30 slides over the outer contact 20 and the guide tube mechanically guides the outer contact 40. Beforehand, the helical spring 6 is wound around the outer contact 20 and, when the body 13 is inserted, comes into axial abutment firstly against a shoulder of the guide tube 5 and secondly against the shoulder that forms the junction between the outer contact 30 and the outer contact 40.

Advantageously, the electrically conductive bodies are obtained by stamping.

Alternatively, step iv′/can be carried out with overmolding of the central electrical insulator 51.

FIG. 6 illustrates an alternative embodiment of the coaxial connector 1, which comprises an electrically insulating block 8, arranged between the outer contact 40 and the central contact 41 of the third coaxial line 4 over at least a portion of the axial length of the latter, preferably over its entire axial length. If the insulating block 8 occupies part of the length of the coaxial line 4, impedance matching must be carried out between the area incorporating the block and the area without a solid insulator.

This electrically insulating block 8 comprises at least one axial through hole 80, preferably a plurality that are regularly distributed angularly about the axis X. This insulating block 8 improves the mechanical holding of the sliding central contact 41. The axial hole(s) along the length of the sliding coaxial line 4 decrease(s) the dielectric constant compared to a solid body to approach that of air. In this alternative, the diameter of the sliding coaxial line 4 is increased compared to that without an insulating block 8.

The electrically insulating block 8 is preferably made of an electrically insulating material chosen from an aliphatic polyamide (PA), a liquid crystal polymer (LCP), polyetheretherketone (PEEK) or a mixture thereof.

Finally, the electrically insulating block 8 is not fixed both to the outer contact 40 and to the central contact 41, allowing slight relative axial sliding between these two contacts during prestressing against the PCB or the filter to be connected.

The PCBs that need to be connected together by one or more coaxial connectors 1 that have just been described may use fragile coatings which are incompatible with the bearing and friction forces of the coaxial connectors 1. These coatings, typically made of tin, allow cost savings.

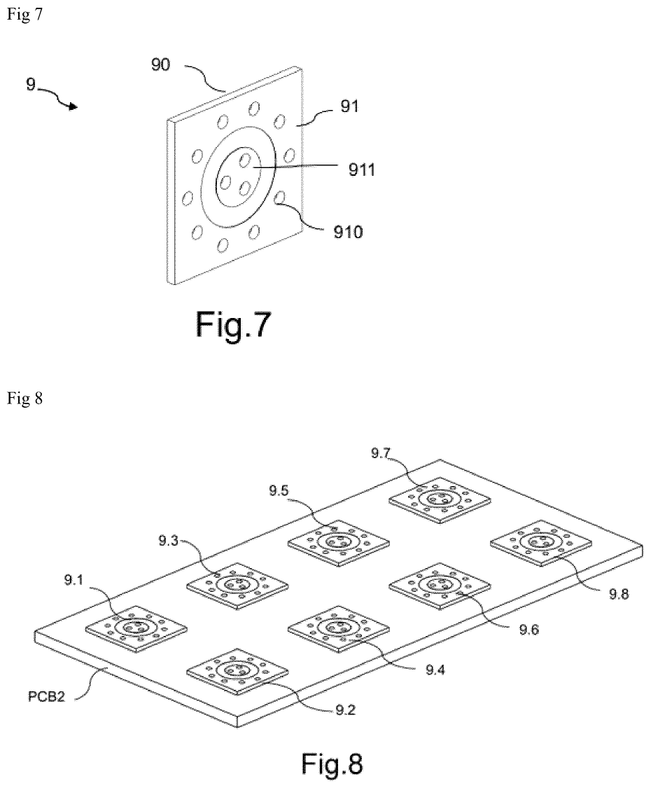

To guarantee bearing and friction in order to establish a reliable connection between a unitary coaxial connector 1 and a PCB, the inventors have provided an interconnection plate 9 as illustrated in FIG. 7. The interconnection plate 9 simplifies the PCB and reduces the cost of manufacture thereof.

This interconnection plate 9 has a main face 90 which is intended to be connected by being secured, in particular soldered, to a printed circuit (PCB2) or to a module or to a filter. The other main face 91 is intended to be connected to the coaxial line 4 of the connector. Thus, it has two concentric electrically conductive tracks 910, 911 separated by an electrical insulator. These tracks 910, 911, which are intended to bear against the outer contact 40 and the central contact 41, respectively, may be made of a hard metal coating, typically made of nickel-gold alloy or silver, which is compatible with the pressure applied by a coaxial connector 1.

Thus, an interconnection plate 9 reliably routes the signal to be transmitted between firstly the central contacts 21, 31, 41 and the signal track of the PCB2 and secondly the outer contacts 20, 30, 40 of the coaxial connector 1 and the electrical ground of the PCB2.

FIG. 8 shows a portion of a multi-way coaxial connection assembly 100 with a PCB2 on which multiple interconnection plates 9.1 to 9.8 are arranged and secured parallel to each other.

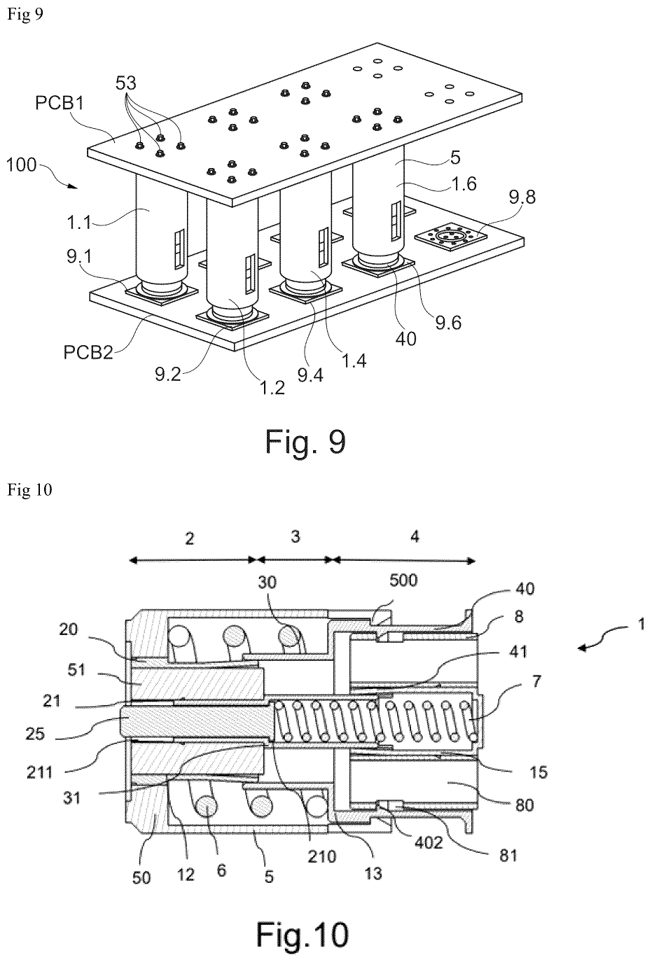

FIG. 9 shows the multi-way assembly 100 with a plurality of coaxial connectors 1.1 to 1.8, each connected by their coaxial line 2 to a PCB1 and to the PCB2 via their coaxial line 4 and an interconnection plate 9.1 to 9.8 secured as shown in FIG. 8.

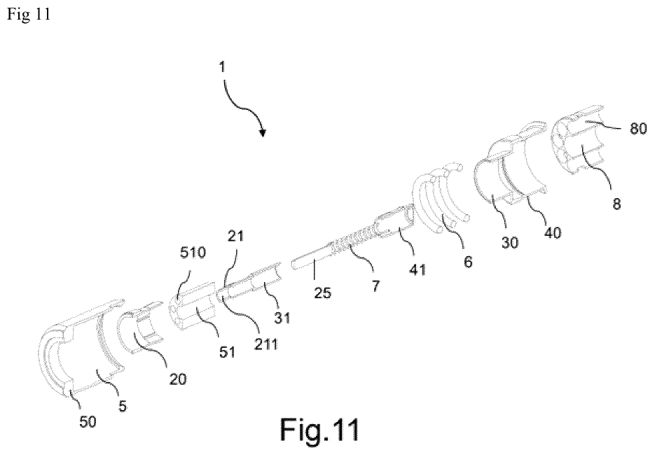

FIGS. 10 and 11 show a second embodiment of the unitary coaxial connector 1 according to the invention, which is intended to be connected, without welding or soldering, to two PCBs by its two ends.

The first electrically conductive body 14 here comprises two components, namely a cylindrical sleeve that forms the central contact 31 and the central contact 21 with a free end in the form of a split socket 211 and a contact tip 25, which produces the electrical connection between the central contact 21 and the printed circuit PCB1, that is mounted so as to be axially mobile in the sleeve 31, 21 with an axial stop produced by an outer shoulder 210 in an internal shoulder of the sleeve 31, 21.

The elastic element 7 exerts a force on the shoulder 210 of the contact tip 25 in order to provide a contact pressure with one of the two PCBs, such as PCB1.

The cylindrical sleeve 31, 21 is integral with the electrical insulating block 51, for example by being press-fitted in an opening in the insulating element 51. The electrical insulator 51 is itself integral with the outer contact 20.

The guide element 5 is integral with the outer contact 20. The guide element 5 here is electrically conductive to provide for the electrical connection with the ground track of the PCB1, via its base portion 50 in the form of a ring. Moreover, given the more compact geometry of the connector according to this second embodiment, the guide element 5 can advantageously be made of a metallic material, in particular by machining. The guide element 5 comprises an internal surface mechanically guiding the outer contact 40. The guide element 5 can also retain the outer contact 40 axially, in particular by means of fastening lugs 500 at its free end which hook onto a shoulder of the outer contact 40.

The contact tip 25, which is mobile relative to the outer contact 20 and therefore to the guide element 5, ensures electrical signal connection to the PCB1 under all circumstances. The guide element 5 simultaneously provides for the electrical ground connection to PCB1.

The electrical signal passing through the sleeve 31, 21 is transmitted to the contact tip 25 via the petals of the split socket 211 at the free end.

The second body 15 is integral with the electrical insulator 8, in particular by press-fit. The electrical insulator 8 is mounted so as to be slidable into the outer contact 40, which allows electrical connection both of the outer contact 40 to the ground track of the other of the two PCBs, such as PCB2, and of the central contact 41 to the signal track of PCB2. The electrical insulator 8 is retained axially in the outer contact 40, in particular by means of tongues 402 of the latter, which are inserted into an opening 81 in the insulator 8.

Thus, a unitary coaxial connector 1 according to this second embodiment, as illustrated in FIGS. 10 and 11, makes the electrical contact at each of these ends, solely by way of the force exerted by each of the elastic elements 6 and 7 with the signal and ground tracks of PCB 1 and PCB2. No soldering or welding is therefore required.

Other variants and improvements may be provided without thereby departing from the scope of the invention.

1. A unitary coaxial connector, suitable to connect two parallel printed circuits (PCB1, PCB2) for transmitting radio frequency, RF, signals, having a longitudinal axis X, comprising:
three coaxial lines that are adjacent along the longitudinal axis X and increase in diameter from one adjacent line to the other, from one of the longitudinal ends of the connector to the other of its longitudinal ends, each of the lines comprising a central contact and an outer contact arranged around the central contact, at least one central contact of a coaxial line being slidable into a central contact of one of the other lines adjacent thereto, at least one outer contact of a coaxial line being slidable into an outer contact of one of the other lines adjacent thereto, so that the length of the intermediate coaxial line can vary, the volume between the central contact and the outer contact of the intermediate line being devoid of a solid electrical insulator, the central contacts of the coaxial lines being form by a first electrically conductive body having at least two different diameters that form the central contact of the first coaxial line and the central contact of the second coaxial line, respectively, and by a second electrically conductive body that forms the central contact of the third coaxial line, which is slidable over the central contact of the second coaxial line, which is larger in diameter than that of the first coaxial line, the first electrically conductive body extending from the one of the longitudinal ends of the connector and the second electrically conductive body extending from the other of its longitudinal ends;
a guide element, the internal surface of which is suitable for mechanically guiding at least the outer contact of the coaxial line which extends from one of the longitudinal ends of the connector.

2. The unitary coaxial connector as claimed in claim 1, the second electrically conductive body comprising an open end comprising petals in mechanical and electrical contact on the outer surface of the first electrically conductive body.

3. The unitary coaxial connector as claimed in claim 1, the guide element being suitable for guiding the larger-diameter outer contact.

4. The unitary coaxial connector as claimed in claim 1, the guide element being integral with the outer contact of the coaxial line which extends from the other of the longitudinal ends of the connector, which is opposite to that from which the outer contact mechanically guided by the guide tube extends.

5. The unitary coaxial connector as claimed in claim 4, the guide element being integral with the smaller-diameter outer contact.

6. The unitary coaxial connector as claimed in claim 1, the guide element also being suitable for mechanically retaining the outer contact of the coaxial line.

7. The unitary coaxial connector as claimed in claim 1, a single coaxial line being slidable into another coaxial line, the outer contact of the third coaxial line being integral with the outer contact of the second coaxial line with a narrowing in diameter.

8. The unitary coaxial connector as claimed in claim 7, comprising:
a third electrically conductive body that forms the outer contact of the first coaxial line, which is integral with the guide element;
a fourth electrically conductive body having two different diameters that form the outer contact of the second coaxial line and the outer contact of the third coaxial line, respectively, the outer contact of the second coaxial line being slidable over the outer contact of the first coaxial line, the outer contact of the third coaxial line, which is larger in diameter than that of the second coaxial line, being mechanically guided by the guide element.

9. The unitary coaxial connector as claimed in claim 8, comprising at least one elastic return means for returning the fourth electrically conductive body to an unfurled end position relative to the third electrically conductive body.

10. The unitary coaxial connector as claimed in claim 1, comprising at least one elastic return means for returning the second electrically conductive body to an unfurled end position relative to the first electrically conductive body.

11. The unitary coaxial connector as claimed in claim 10, the elastic return means consisting of a helical spring which is accommodated in a bore in the larger-diameter central contact of the first electrically conductive body and in axial abutment against the blind end of a tube that forms the central contact of the second electrically conductive body.

12. The unitary coaxial connector as claimed in claim 9, comprising at least one elastic return means for returning the second electrically conductive body to an unfurled end position relative to the first electrically conductive body, and wherein:
the guide element is electrically conductive and integral with the outer contact formed by the third electrically conductive body;
the first electrically conductive body comprises a cylindrical sleeve that forms the central contacts of the first and second coaxial lines and a contact tip mounted so as to be axially mobile in the sleeve with an axial stop;
the second electrically conductive body that forms the central contact of the third coaxial line being mounted so as to be slidable relative to the fourth electrically conductive body that forms the outer contact of the second coaxial line and the outer contact of the third coaxial line,
in such a way that the force exerted by each of the elastic return means can produce the electrical connection between, firstly, at one of the longitudinal ends of the connector, the contact tip and the guide element and, respectively, the signal track and the ground track of a first printed circuit board (PCB1) and, secondly, at the other of the longitudinal ends of the connector, the central contact and the outer contact of the third coaxial line and, respectively, the signal track and the ground track of a second printed circuit board (PCB2).

13. The unitary coaxial connector as claimed in claim 8, comprising an electrically insulating block arranged between the outer contact and the central contact of the third coaxial line over at least a portion of the axial length of the latter, the electrically insulating block comprising at least one axial through hole.

14. The unitary coaxial connector as claimed in claim 1, the guide element being made of an electrically insulating material chosen from an aliphatic polyamide (PA), a liquid crystal polymer (LCP), polyetheretherketone (PEEK) or a mixture thereof.

15. The unitary coaxial connector as claimed in claim 1, the material of which the contacts are made being a copper alloy devoid of lead and beryllium.

16. The unitary coaxial connector as claimed in claim 1, the outer contact of one of the coaxial lines at one longitudinal end of the connector comprising at least one lug intended to be used for permanent electrical and mechanical connection to a printed circuit board (PCB1).

17. The unitary coaxial connector as claimed in claim 1, the outer contact of one of the coaxial lines at one longitudinal end of the connector comprising, at its free end, two concentric flanges, one inside the other to form two staircase steps, the outer flange of which extends radially outwards.

18. A coaxial connector assembly, suitable for connecting two parallel printed circuit boards (PCB1, PCB2), comprising:
at least one unitary coaxial connector as claimed in claim 1, of which one of the coaxial lines at one longitudinal end of the connector is intended to be connected by being secured, to a first printed circuit (PCB1),
at least one interconnection plate, one main face of which is intended to be connected by being secured, to a second printed circuit board (PCB2), and the other main face of which is intended to be connected to another of the coaxial lines at the other longitudinal end of the connector.

19. A method for producing a unitary coaxial connector as claimed in claim 8, comprising the following steps:
i/ supplying the third electrically conductive body that forms the outer contact of a first coaxial line;
ii/ supplying the fourth electrically conductive body having two different diameters that form the outer contact of a second coaxial line and the outer contact of a third coaxial line, respectively,
iii/ mechanically assembling a first connector subassembly comprising the first electrically conductive body having at least two different diameters, which form the central contact of the first coaxial line and the central contact of the second coaxial line, respectively, and the second electrically conductive body that forms the central contact of the third coaxial line, which is slidable over the central contact of the second coaxial line, which is larger in diameter than that of the first coaxial line;
iv/ overmolding the guide element on the third electrically conductive body so as to form a second connector subassembly and then mechanically assembling the first subassembly in the second subassembly;
or
iv/′ overmolding the guide element both on the third electrically conductive body and on the central contact of the first coaxial line of the first connector subassembly so as to form a second connector subassembly;
v/ mechanically assembling the fourth electrically conductive body in the second subassembly in such a way that the outer contact of the second coaxial line slides over the outer contact of the first coaxial line and the guide element mechanically guides the outer contact of the third coaxial line.
